(19) United States
(12) Patent Application Publication
(10) Pub. No.: US 2004/0089723 A1
(43) Pub. Date: May 13, 2004

(54) Recording medium reading device and transaction apparatus

(76) Inventor: Seiji Moriya, Kyoto (JP)

Correspondence Address: DICKSTEIN SHAPIRO MORIN &, OSHINSKY LLP, 2101 L Street NW, Washington, DC, 20037-1526, US

(21) Appl. No.: 10/648,377

(22) Filed: Aug. 27, 2003

(30) Foreign Application Priority Data
Aug. 30, 2002 (JP) 2002-253142

(51) Int. Cl. G06K 13/00

(52) U.S. Cl. 235/475

(57) ABSTRACT

A recording medium reading device is disclosed that allows visual confirmation of receipt of a recording medium, such as a card. The device can be used in a transaction apparatus, to effectively prevent dishonest acts such as stealing a card or retrieving information read from a card. As a result, use of cards and other recording means can be made more secure. The recording medium reading device can include a receiving portion, into which a recording medium is received, conveyance means for conveying the recording medium inside, reading means for reading information recorded on the recording medium, and control means for controlling these elements. At least a portion of the receiving portion is an observation enabling member, through which a recording medium received into the receiving portion can be visually confirmed from outside.

This application claims priority to Japanese patent application JP-2002-253142, filed Aug. 30, 2002.

### FIELD OF THE INVENTION

The present invention relates to a recording medium reading device for reading data recorded on a recording medium, for example, a magnetic card, integrated circuit (IC) card, or the like, and a transaction apparatus, such as an automatic teller machine (ATM), a cash dispenser (CD), or a ticket machine, provided with the recording medium reading device.

### BACKGROUND OF THE INVENTION

With conventional recording medium reading devices, such as a card reader or the like, for reading a magnetic card, a possibility exists that a magnetic card is dishonestly acquired, or information recorded on a magnetic card is dishonestly acquired by various contrivances.

One such contrivance involves a sheet-shaped member made to cause a magnetic card to become jammed in a card insertion port. Thus, a user unwittingly inserts a magnetic card, which magnetic card becomes lodged in the port and can be dishonestly acquired by a thief after the user leaves. The thief can stick the sheet-shaped member to a bottom surface of a card conveyance passage on the card insertion port, and can pull out the magnetic card together with the sheet-shaped member after the magnetic card has become lodged in the port, thus enabling the thief to dishonestly acquire the magnetic card.

Japanese Patent Publication No. JP-A-2000-099637 describes a card reader for prevention of such theft. The card reader includes a shutter plate provided on a card insertion port to open and close the card insertion port. The shutter plate is moved from a closed position to an opened position upon insertion of a card to permit the card to be inserted inside. A second shutter plate, provided in addition to the first-mentioned shutter plate is moved from a closed position to an opened position in a direction opposed to the direction in which the first-mentioned shutter plate is moved from a closed position to an opened position”

With this prior example, the two shutter plates are operatively closed in opposite directions, so that even when the sheet-shaped member is stuck to a bottom surface of a card conveyance passage, the sheet-shaped member blocks the card conveyance passage after the closing motion. Therefore, a magnetic card cannot enter inside from the card insertion port and becomes lodged in the port, so that a user can retrieve the magnetic card, which is blocked in the course of insertion, thus preventing dishonest acquisition of the magnetic card.

Another contrivance is to mount a faked card insertion port adjacent to the card insertion port and acquire magnetic data of a magnetic card inserted in the faked port.

Japanese Patent Publication No. JP-A-2001-022894 proposes an apparatus for prevention of such a dishonest act. The proposed magnetic card transaction apparatus includes a card slot for insertion of a magnetic card, card conveyance means for taking in a magnetic card inserted from the card slot, and temporary stoppage means for temporarily stopping the taking-in action of the magnetic card by the card conveyance means when a rear end of the magnetic card protrudes outside from the card slot.

Thereby, only a part of information recorded on a magnetic card can be read in the faked card insertion port, so that it is possible to prevent an act in which information of the magnetic card is dishonestly acquired.

Japanese Patent Publication No. JP-A-2001-067514 proposes a further apparatus for prevention of such a dishonest act. The proposed magnetic card transaction apparatus includes an apparatus casing formed with an opening for a magnetic card insertion/discharge, and a magnetic card reader arranged in the apparatus casing. The magnetic card reader includes a card slot for insertion/discharge of a magnetic card, card conveyance means for taking inside a magnetic card, which is inserted from the card slot, and discharging the magnetic card outside through the card slot, and a magnetic head for reproducing data from the magnetic card taken inside. A portion surrounding the card slot is at least partially formed with a projection, which protrudes in a magnetic card discharge direction.

With this magnetic card transaction apparatus, the projection protruding in the magnetic card discharge direction prevents dishonest acquisition of information recorded on a magnetic card.

With the card reader shown in Japanese Patent Publication No. JP-A-2000-099637, however, a threadlike member can be used in place of the sheet-shaped member, allowing dishonest acquisition by conveying a magnetic card inside to become lodged, and pulling out the magnetic card together with the threadlike member.

Also, with magnetic card transaction apparatus shown in Japanese Patent Publication Nos. JP-A-2001-022894 and JP-A-2001-067514, information recorded on a magnetic card can be dishonestly acquired by elaborately fabricating an imitation of a card insertion port (an apparatus casing formed with an opening for a magnetic card insertion/discharge port, and a card slot).

It would be advantageous to have improved techniques for preventing dishonest acquisition of a magnetic card and its recorded information.

### BRIEF SUMMARY OF THE INVENTION

The invention provides a recording medium reading device with a receiving portion into which a recording medium is received. At least a portion of the receiving portion is an observation enabling member, through which a recording medium received into the receiving portion can be visually confirmed from outside. The device can also include conveyance means for conveying the recording medium inside, reading means for reading information recorded on the recording medium, and control means for controlling these elements.

The recording medium can be a medium, such as a magnetic card and/or an IC card, capable of recording and retaining information.

The receiving portion can include a slot neighboring portion into which the recording medium is received. It can also include a portion toward a side of a slot from an opening/closing shutter in the case where the opening/closing shutter is provided to control approval or denial of receipt of the recording medium.

The conveyance means can include conveyance rollers and/or a conveyance belt for taking the recording medium into a casing, and a motor for rotating and driving the rollers and/or the conveyance belt.

The reading means can include a magnetic head for reading information recorded on a magnetic recording medium such as a magnetic card or the like, and/or a contact IC contact and/or a non-contact antenna for reading information recorded on an IC recording medium such as an IC card or the like.

The control means can include a control device such as CPU, MPU, or the like, and one or more ROM, RAM, EEPROM components.

The recording medium reading device can include a magnetic card reader or magnetic card reader/writer capable of magnetically reading information recorded on magnetic stripes of a magnetic card, a contact integrated circuit card reader or contact IC card reader/writer capable of contacting with an IC chip to read information recorded on an IC card, a non-contact IC card reader or non-contact IC card reader/writer capable of having communication with an IC chip in a non-contact state to read information recorded on an IC card, or a hybrid card reader or hybrid card reader/writer capable of reading information recorded on a magnetic card, an IC card, or a hybrid card provided with magnetic stripes and an IC chip.

The observation enabling member can be a transparent or translucent member such as acrylic, plastic, glass, or the like; a lattice-shaped member formed by braiding rod-shaped members lengthwise and crosswise or in one direction, lengthwise or crosswise with spaces therebetween; or a mesh-shaped member. Also, while a translucent or transparent material suffices to enable visually confirming a recording medium in a receiving portion, a clear, transparent material of high transparency provides for good observation.

Part of the receiving portion that is the observation enabling member can include a part on a side of the slot, and specifically a part through which a recording medium in the receiving portion can be visually confirmed in a direction obliquely intersecting a receiving direction of the recording medium. Although it suffices that a part of the receiving portion be an observation enabling member, the whole receiving portion or the whole casing of the recording medium reading device may be an observation enabling member.

A shutter can be between the receiving portion and the body, and a part of the receiving portion that is the observation enabling member can be a portion, e.g., one surface, of an outer package outside of the shutter and/or a portion, e.g., one surface, of a conveyance passage for the recording medium. The shutter can be a metallic plate, opening and closing of which is controlled by a solenoid. The portion, e.g., one surface, can be disposed in an upper area in the case where a magnetic medium is horizontally received, and disposed in a right or left area in the case where a magnetic medium is vertically received.

Also, the invention provides a transaction apparatus including the recording medium reading device and input means for receiving input from a user. The input means can include an input device, such as a touch panel for accepting a predetermined input, ten keys for accepting an input of a numeral, or the like, to receive input from a user.

The transaction apparatus can perform processing related to transactions, such as a bank transfer processing, a deposit processing, a pull down processing, a payment processing with a credit card, or the like.

The transaction apparatus includes an apparatus, such as an ATM, CD, credit card dispenser, ticket machine, or the like, for executing transaction processing making use of a recording medium.

The recording medium reading device can be housed in a casing, and a portion of the casing in the vicinity of the recording medium reading device can be an observation enabling member.

The vicinity of the recording medium reading device is formed from a portion of a front panel such as a guidance panel provided on the casing in the vicinity of the receiving portion of the recording medium reading device.

Advantageously, it is possible to immediately find a contrivance made on the receiving portion through visual confirmation.

### BRIEF DESCRIPTION OF THE DRAWINGS

FIG. 1 is a perspective view showing an outside appearance of an ATM;

FIGS. 2A and 2B are views illustrating outside appearances of a plan surface and a side surface of a card reader;

FIGS. 3A to 3D are views illustrating a discharging and receiving port neighboring portion of the card reader;

FIG. 4 is a side, cross sectional view showing constituents of the card reader;

FIGS. 5A and 5B are views illustrating a neighborhood of a card discharging and receiving port; and

FIGS. 6A and 6B are views illustrating sides of other embodiments.

### DETAILED DESCRIPTION OF THE INVENTION

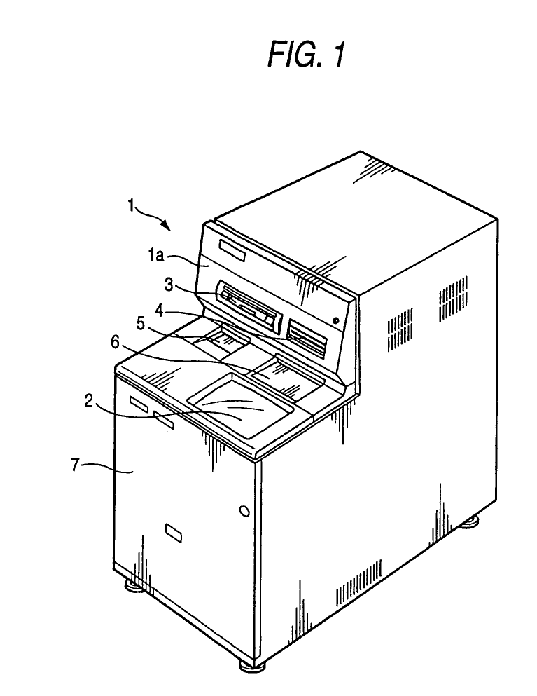

FIG. 1 shows a perspective view of ATM 1. The ATM 1 is installed in a financial institution such as a bank, or the like. On a front surface of an upper portion of ATM 1 a touch monitor 2 serves as a monitor for displaying transactions to a customer and as a touch panel for permitting input. Also included are a banknote discharging and receiving port 3, a card reader 4 with a card discharging and receiving port 4a, into which a magnetic card is inserted, a coin input-output port 5, and a note input-output port 6. Further included is a control device (not shown), thus permitting transactions such as deposit, withdrawal, transfer, banknote register, balance inquiry, or the like.

In addition, the substantially vertical front surface provided with the banknote discharging and receiving port 3 and the card reader's discharging and receiving port 4a constitutes a front surface panel 1a and is made of an opaque resin material.

When the ATM 1 is operated, guidance for various transactions such as input guidance, procedure of operation, receipt guidance, or the like, is displayed on the touch monitor 2, based on which a customer performs an input operation by touch input.

Provided on a lower portion of the front surface of the ATM 1 is a single swing door 7, which a clerk can open and close to afford inspection of an interior, and through which coins and notes are freely taken out and put in.

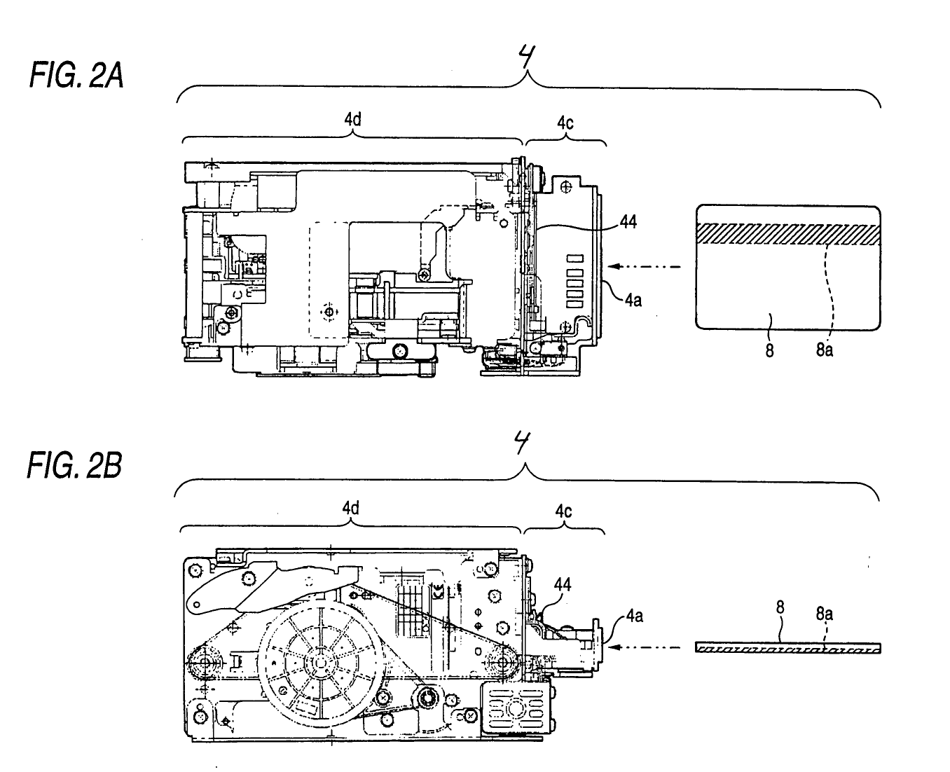

To use the ATM 1 described above, a user can insert a cash card 8 (FIGS. 2A, 2B) into the card discharging and receiving port 4a to perform transactions such as deposit, withdrawal, transfer, banknote register, balance inquiry, or the like.

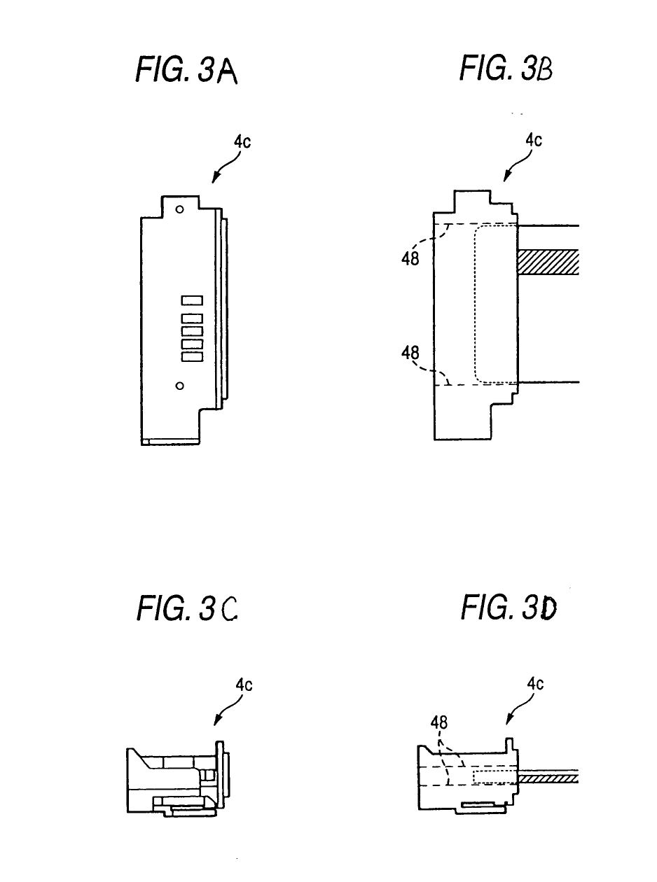

The external appearance and outer package of a card reader (card reader/writer) 4 provided with the card discharging and receiving port 4a will be described with reference to a plan view (FIG. 2A) and a side view (FIG. 2B) and an illustration of a discharging and receiving port neighboring portion 4c shown in FIGS. 3A to 3D.

The card reader 4 includes a body 4d and the discharging and receiving port neighboring portion (slot neighboring portion) 4c as shown in the plan view (FIG. 2A) and the side view (FIG. 2B).

As shown in plan views of FIGS. 3A and 3B and side views of FIGS. 3C and 3D, the discharging and receiving port neighboring portion 4c includes a portion protruding from the body 4d (see FIGS. 2A and 2B) and is made of a transparent acrylic resin.

Accordingly, a user inserts a cash card 8 with magnetic stripe 8a on its back surface, as shown in FIGS. 2A and 2B, into the card discharging and receiving port 4a mounted on a right side of the discharging and receiving port neighboring portion 4c in the figure. The cash card 8 is seen through the transparent portion as shown in FIGS. 3B and 3D and so it is possible to confirm the manner in which the inserted cash card 8 is received. In addition, the card discharging and receiving port 4a permits the cash card 8 to be inserted and to be discharged when a transaction is terminated.

Provided on the discharging and receiving port neighboring portion 4c in the vicinity of the body 4d as shown in FIGS. 2A and 2B is an opaque shutter plate 44 made of a metallic material, which plate controls approval or denial of insertion of the cash card 8.

As described above, the discharging and receiving port neighboring portion 4c is transparent. Therefore, presence or absence of a suspicious material can be confirmed by observing the discharging and receiving port neighboring portion 4c from obliquely upward when a user is going to insert a cash card 8.

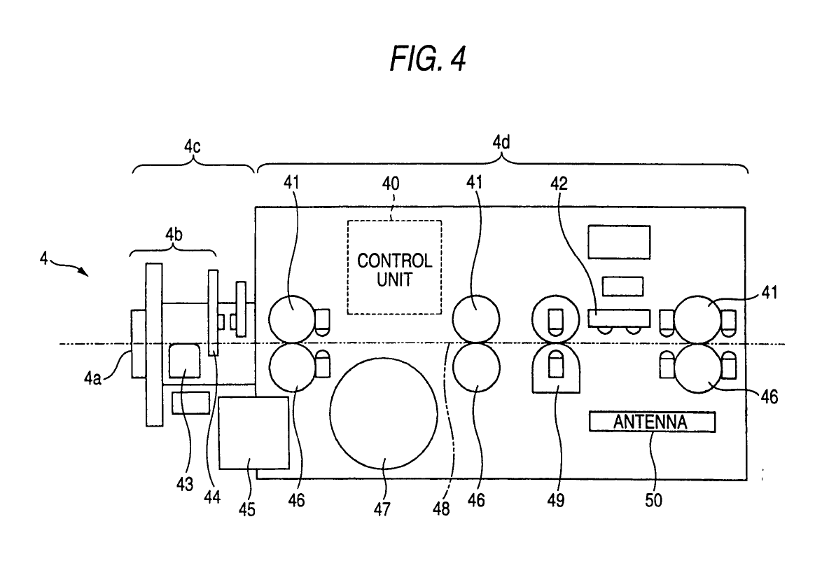

Subsequently, outlines of respective constituents of the card reader 4 together with a side, cross sectional view of the card reader 4 shown in FIG. 4 will be described.

The card reader 4 houses therein a control unit 40 to perform a reading processing of magnetic data on a cash card 8, which is provided on a back surface thereof with magnetic stripes 8a to be able to magnetically record data (information), through control by the control unit 40. In addition, the card reader 4 is capable of data processing (reading processing and writing processing) on not only a magnetic card but also a contact type IC card, a non-contact type IC card, and a composite card, which is provided with magnetic stripes and an IC chip, for higher flexibility. In this embodiment, the reading function of magnetic data is made use of for the ATM 1.

A conveyance passage 48 is connected to an interior of the card discharging and receiving port 4a, and a plurality of pairs of conveyance means with pressing rollers 41 and drive rollers 46 facing each other are arranged along the conveyance passage 48. The drive rollers 46 are reciprocally controlled by a DC motor 47 whereby the conveyance means conveys a cash card 8 into port 4a to receive it and outward through port 4a to discharge it.

Provided along the conveyance passage 48 in the vicinity of the card discharging and receiving port 4a is a detection sensor (magnetic sensor) 43 for detecting a cash card 8. Thereby, a region extending from the shutter plate 44, which controls approval or denial of insertion of the cash card 8, to the card discharging and receiving port 4a functions as a card insertion sensing portion (recording medium insertion sensing portion) 4b.

Also, the shutter plate 44 is inside the detection sensor 43 along conveyance passage 48, and a solenoid 45 for controlling opening and closing of the shutter plate 44 is illustratively in a position below the shutter plate 44. When the detection sensor 43 detects a cash card 8, the solenoid 45 lifts the shutter plate 44 under control of the control unit 40 to open the conveyance passage 48. At this time, the control unit 40 drives the DC motor 47 in a receiving direction to convey the cash card 8 inward.

Further, a magnetic head 49 and an IC contact 42 are arranged along the conveyance passage 48 on a back side of card reader 4 (right side in the figure), and an antenna 50 is provided in the vicinity of the conveyance passage 48 on the back side. The magnetic head 49 reads recorded data on the cash card 8. The IC contact 42 causes a slider to make contact with an IC chip of a contact type IC card to allow processing of data on the contact type IC card. Also, the antenna 50 allows processing of data stored on a non-contact type IC card or a composite card.

The control unit 40 provides drive and other control signals to the DC motor 47, which conveys a cash card 8 on the conveyance passage 48 in the manner described above. In addition, control unit 40 performs data processing operations, including, but not limited to, reading and writing operations on various cash cards 8 described above.

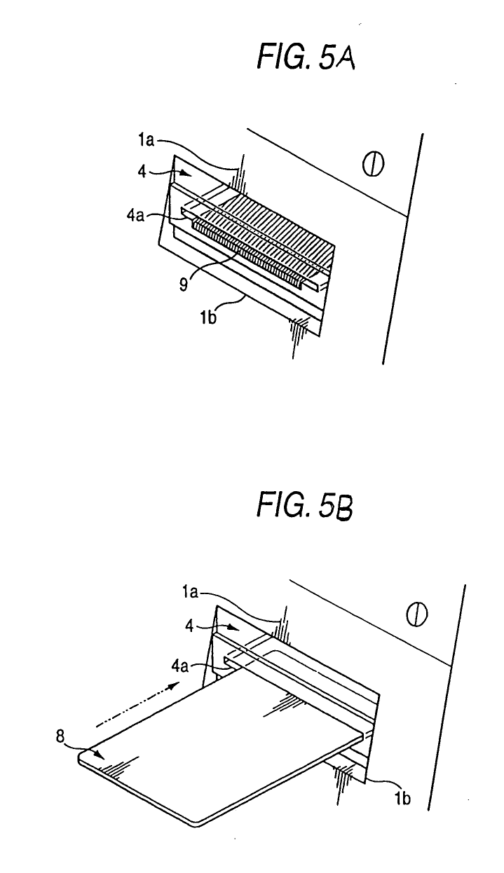

FIG. 5A shows how card reader 4 with a transparent portion as described above makes it possible to definitely visualize and confirm mounting of a suspicious material in the vicinity of the card discharging and receiving port 4a. This is true even when a sheet 9 for dishonest acquisition of a card is applied on the card reader 4 mounted on a card reader mount window 1b formed on the front panel 1a.

As a result, personnel, watchmen, or the like in a bank can approach the ATM 1 to directly confirm, or remotely confirm, whether a suspicious material is mounted at the card discharging and receiving port 4a. This makes it possible to prevent a contrivance for dishonest acquisition of a cash card 8 or for dishonest reading of magnetic or other recorded data, thus improving security.

FIG. 5B shows how the manner in which a cash card 8 is inserted can be visualized and confirmed through a transparent portion of card reader 4. As a result, the cause for a card becoming lodged can be visually confirmed with ease even in the case where the cash card 8 is lodged outside of the shutter plate 44, so that it is possible to quickly perform maintenance to eliminate blockages. The waiting time for repair of trouble is reduced, thus enhancing the user's satisfaction.

Since a user personally can visually confirm the presence of a suspicious material when the user inserts a cash card 8, card reader 4-9-3 safe to use. Further, since the shutter plate 44 is made of an opaque metallic plate, it is possible to maintain secrecy of internal construction of body 4d for data reading while keeping visibility for catching a dishonest act.

In addition, illumination means, such as LED, fluorescent lamp, incandescent lamp, or the like, which emits light simultaneously with detection of insertion of a cash card 8, may be provided inside the port neighboring portion 4c. As a result, the port neighboring portion 4c is illuminated brightly, thus enabling easy detection of a suspicious material.

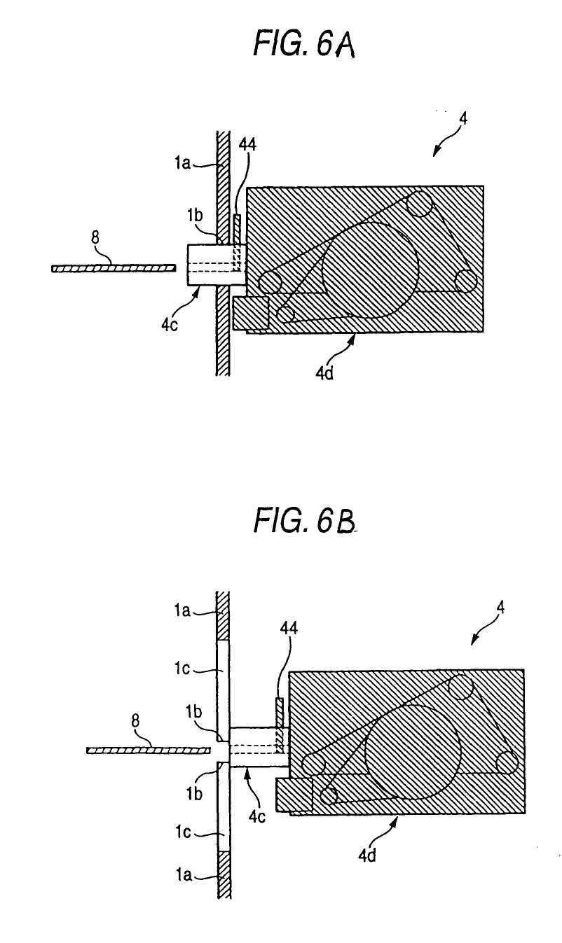

While the above-described embodiment is configured such that the card discharging and receiving port 4a of the card reader 4 just fits into the card reader mount window 1b of the front panel 1a of the ATM 1, a portion of a transparent discharging and receiving port neighboring portion 4c may protrude from the card reader mount window 1b of the front panel 1a of the ATM 1 as shown in a side view in FIG. 6A. As a result, a user can visually confirm whether a contrivance for a dishonest act is made on the discharging and receiving port neighboring portion 4c of the card reader 4 from a wide range of angles.

As shown in a side view in FIG. 6B, a card reader mount window 1b on the front panel 1a of the ATM 1 alternatively may extend laterally and a discharging and receiving port neighboring portion 4c of the card reader 4 may be fully inside the card reader mount window 1b, so that only the card reader mount window 1b is present on the exterior of front panel 1a.

In this case, a transparent panel 1c made of a transparent member (for example, a transparent acrylic resin, or the like) in the vicinity of the card reader mount window 1b enables visual inspection of the interior of the transparent discharging and receiving port neighboring portion 4c. As a result, it is possible to improve security and provide an attractive outside appearance.

Also, the insertion port (slot) and the discharge port for a cash card 8 may be separate. In this case, it suffices that an insertion port neighboring portion is made of a transparent material.

If the card insertion sensing portion 4b (FIG. 4) is transparent, the portion of the discharging and receiving port neighboring portion 4c, that extends from the shutter plate 44 to the body 4d may be made of an opaque member. As long as the card insertion sensing portion 4b is transparent, a contrivance for a dishonest act can be visually confirmed, providing necessary and sufficient security.

The portion of the transparent discharging and receiving port neighboring portion 4c below the conveyance passage 48 may be formed of an opaque material. In order to prevent a contrivance for a dishonest act, it suffices that a user can confirm the receiving operation of a cash card 8. Even in the case where the bottom of the conveyance passage 48 or the like, which cannot be seen through the cash card 8, is not transparent, it is possible to prevent a dishonest act by visual inspection.

The portion of the transparent panel 1 (FIG. 6B), below the discharging and receiving port neighboring portion 4c, may also be made of an opaque material. In this case, a user can easily confirm presence or absence of a suspicious material without strain by obliquely observing the discharging and receiving port neighboring portion 4c from ordinary eye level.

The bottom surface of the conveyance passage 48 within the discharging and receiving port neighboring portion 4c (or within the card insertion sensing portion 4b) may bear a pattern such as a transverse striped pattern of yellow and black, a checked pattern or the like, and characters can also be printed on it. This makes it difficult to create an counterfeit article which is the same in pattern and color and even when such an article is created, mounting it without discrepancy is difficult and so it is possible to easily detect a counterfeit article.

The shutter plate 44 and/or the body 4d may be made of a transparent material. In this case, it becomes possible to visually confirm a card in a further back position, and so it becomes possible to prevent a dishonest act in which a contrivance is made on the back side of the card reader 4. Also, the DC motor 47 may be a reversible pulse motor.

As used in the claims, the following terms are exemplified by the following components described above and encompass modifications, variations, and equivalents thereof. The term “transaction apparatus” is exemplified by the ATM 1. A “neighboring portion of a recording medium reading device” is exemplified by the transparent panel 1c. “Input means” is exemplified by the touch monitor 2. A “recording medium reading device” is exemplified by the card reader 4. A “slot portion” is exemplified by the discharging and receiving port neighboring portion 4c. A “recording medium” is exemplified by the cash card 8. “Control means of a recording medium reading device” is exemplified by the control unit 40. “Reading means” is exemplified by the IC contact 42, magnetic head 49 and the antenna 50. “Conveyance means” is exemplified by the DC motor 47. An “observation enabling member” is exemplified by the transparent member. “Control means of the transaction apparatus” is exemplified by the control device.

While preferred embodiments of the invention have been described and illustrated above, it should be understood that these are exemplary of the invention and not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed as new and desired to be protected by Letters Patent of the United States is:

1. A recording medium reading device comprising:
a receiving portion into which a recording medium is received;
conveyance means for conveying the recording medium inside the recording medium reading device;
reading means for reading information recorded on the recording medium; and
control means for controlling the conveyance means and the reading means,
wherein at least a portion of the receiving portion is an observation enabling member, through which a recording medium received into the receiving portion can be visually confirmed from outside the recording medium reading device.

2. A transaction apparatus comprising the recording medium reading device according to claim 1, further comprising input means for receiving input from a user for processing a transaction.

3. The transaction apparatus according to claim 2, wherein the recording medium reading device housed in a casing, and a portion of the casing neighboring the recording medium reading device is an observation enabling member.

4. A recording medium reading device comprising:
a receiving portion into which a recording medium is received;
a conveyor conveying the recording medium inside the recording medium reading device;
a reader reading information recorded on the recording medium; and
a controller controlling the conveyor and the reader,
wherein at least a portion of the receiving portion is an observation enabling member, through which a recording medium received into the receiving portion can be visually confirmed from outside the recording medium reading device.

5. A transaction apparatus comprising a recording medium reading device according to claim 4, and further comprising an input device receiving input from a user to process a transaction.

6. The transaction apparatus according to claim 5, wherein the recording medium reading device is housed in a casing, and a portion of the casing neighboring the recording medium reading device is an observation enabling member.

7. A method of operating a recording medium reading device comprising:
inserting a recording medium into a receiving portion;
conveying the recording medium inside the recording medium reading device;
reading information recorded on the recording medium; and
visually confirming receipt of the recording medium through at least a portion of the receiving portion that is an observation enabling member.

8. A method of operating a transaction apparatus comprising:
inserting a recording medium into a receiving portion;
conveying the recording medium inside a recording medium reading device;
reading information recorded on the recording medium;
visually confirming receipt of the recording medium through at least a portion of the receiving portion that is an observation enabling member; and
inputting information for processing a transaction.
